(19) United States
(12) Patent Application Publication
(10) Pub. No.: US 2008/0267438 A1
(43) Pub. Date: Oct. 30, 2008

(54) Earphone and tuning module of speaker for the earphone

(76) Inventors: Yi-Rong Chen, Taipei City (TW); Pen-Li Chen, Taipei (TW)

Correspondence Address: BRUCE H. TROXELL, SUITE 1404, 5205 LEESBURG PIKE, FALLS CHURCH, VA, 22041, US

(21) Appl. No.: 11/976,918

(22) Filed: Oct. 29, 2007

(30) Foreign Application Priority Data
Apr. 26, 2007 (TW) 096206696

(51) Int. Cl. H04R 1/02

(52) U.S. Cl. 381/345

(57) ABSTRACT

An earphone and a tuning module of a speaker for the earphone include a speaker casing and a speaker unit. The speaker casing provides a resonance chamber to receive the speaker unit. The speaker casing has a front mouth and a rear mouth. The rear mouth further provides at least a rear through hole such that characteristics of different sounds are capable of being emitted by means of size and position of said rear mouth being adjustably reset under a condition of said chamber being not changed.

### BACKGROUND OF THE INVENTION

1. Field of the Invention

The present invention is related to an earphone and particularly to a tuning module of a speaker for an earphone.

2. Brief Description of Related Art

Referring to FIG. 1, Taiwan Patent No. 1268720 discloses an earphone 10, which includes an earphone casing 11 and a speaker module 12 provided in the earphone casing 11. The speaker module 12 further includes a speaker casing 121, which constitutes a resonance chamber 122 and only has a sound output 123, and a speaker unit 13, which is disposed in the resonance chamber 122. The speaker module 12 further provides an electric cord 124. The speaker casing 121 and the earphone casing 11 provides a piercing hole 125, 111 respectively. The electric cord 124 is electrically connected to the speaker unit 13 and extends outward the earphone casing 11 via the piercing holes 125, 111. The speaker module 12 further provides a cover-member 126. The cover member 126 has a plurality of first sound apertures 127 and covers the sound outlet 123. The earphone casing 11 further provides a plurality of decoration holes 112 and is joined to an ear pad 113.

However, the preceding speaker module 12 is incapable of creating different sounds with the speaker casing 121, which is a speaker casing in one single configuration and size, in association with a single speaker unit 13 so that the preceding speaker module 12 provides the same performance as the conventional closed type earphone while sound is tuned.

### SUMMARY OF THE INVENTION

The crux of the present invention is to improve the structure of the speaker unit for an earphone such that the speaker casing is capable of being associated with a single speaker unit or different speaker units to create different sounds.

The primary object of the present invention is to provide an earphone and a tuning module of a speaker for the earphone with which the speaker unit is capable of performing change or improvement on creation of different sounds under a condition of configuration and size of the speaker casing being unchanged.

Another object of the present invention is to provide an earphone and a tuning module of a speaker for the earphone with which different speaker units are capable of performing change or improvement on creation of different sounds under a condition of configuration and size of the speaker casing being unchanged.

### BRIEF DESCRIPTION OF THE DRAWINGS

The present invention can be more fully understood by reference to the following description and accompanying drawings, in which:

FIG. 1 is a plan view of the conventional earphone;

FIG. 2 is a plan view of the first embodiment of an earphone and a tuning module of a speaker for the earphone according to the present invention;

FIG. 3 is a plan view of the second embodiment of an earphone and a tuning module of a speaker for the earphone according to the present invention;

FIG. 4 is a plan view of the third embodiment of an earphone and a tuning module of a speaker for the earphone according to the present invention;

FIG. 5 is a plan view of the fourth embodiment of an earphone and a tuning module of a speaker for the earphone according to the present invention;

FIG. 6 is a plan view of the fifth embodiment of an earphone and a tuning module of a speaker for the earphone according to the present invention;

FIG. 7 is a plan view of the sixth embodiment of an earphone and a tuning module of a speaker for the earphone according to the present invention; and

FIG. 8 is a plan view of the seventh embodiment of an earphone and a tuning module of a speaker for the earphone according to the present invention.

### DETAILED DESCRIPTION OF THE INVENTION

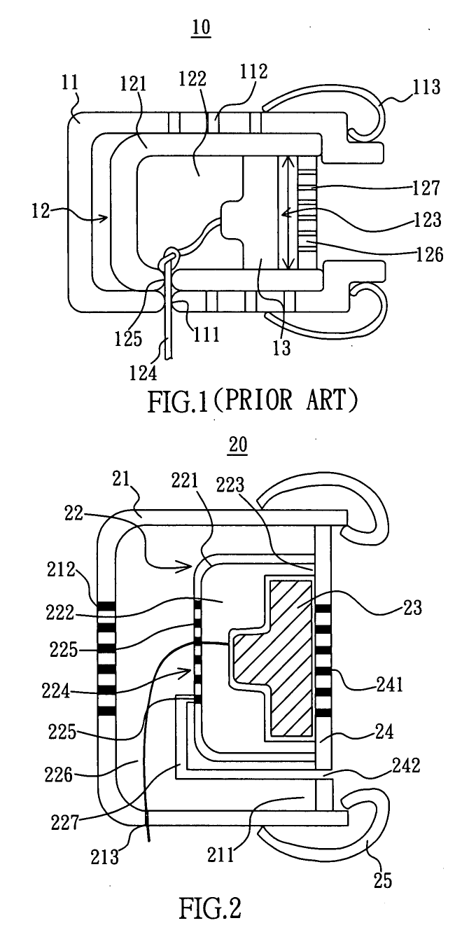

Referring to FIG. 2, the first embodiment of the present invention provides an earphone 20, which includes an earphone casing 21, a speaker module 22 and a speaker unit 23. The earphone casing 21 has a front opening 211 and a plurality of rear through holes 212. The speaker module 22 is disposed at the inner side of the front opening 211 and further includes a speaker body 221 to constitute a resonance chamber 222 with a front mouth 223 and a rear mouth 224. The rear mouth 224 provides a plurality of piercing holes 225. The speaker unit 23 is received in the resonance chamber 222 and is the conventional speak unit capable of emitting sound waves corresponding to sound signals. A cover member 24 is attached to all the front ends of the earphone casing 21, the speaker casing 221 and the speaker unit 23 such that the speaker module 22 is capable of being disposed in the earphone casing 21. The cover member 24 has a plurality of first apertures 241 and a second aperture 242. The first apertures 241 are disposed in front of the speaker unit 23. The speaker module 22 further includes an electrical cord 226 electrically connected to the speaker unit 23 and the electrical cord 226 extends outward the earphone casing 21 via the piercing holes 225, the rear through hole 212 or a piercing hole 213 of the earphone casing 21 to an emitting source of the sound signals. The front end of the earphone casing 21 is jointed to an ear pad 25. The speaker module 22 further includes a frequency modulation chamber 227 for adjustment between mid-frequency and low frequency. The frequency modulation chamber 227 communicates with one of the piercing holes 225 and the second aperture 241.

The great difference of the first embodiment of the present invention from the preceding Taiwan Patent No. 1268726 in that the Taiwan Patent No. 1268726 only provides one sound outlet. In addition, no rear mouth 224 and the frequency modulation chamber 227 are provided with the Taiwan Patent No. 1268726.

Due to the speaker casing 221 having different rear mouths 224, such as piercing holes 225 being different in configuration, size, number and position arrangement, the speaker module 22 is capable of being disposed with the same speaker unit 23 for the speaker unit 23 emitting different sounds or with different speaker units 23 for the speaker units 23 having best sound outputs. This function is not possible to perform with the preceding Taiwan patent.

The speaker module 22 can be modulated to change phase of the sound with single speaker casing 221 such that characteristics of different sounds can be improved or changed under a condition of the same structure of the earphone or the same speaker module without changing resonance chamber. This function is not possible to perform with the preceding Taiwan patent.

The frequency modulation chamber 227 allows air in the resonance chamber 222 to communicate with air outside the cover 24 such that mediant and base of the speaker module 22 can be improved significantly. This function is not possible to perform with the preceding Taiwan patent.

The high frequency response of the speaker module 22 can be changed in accordance with size and position of the rear mouth 224 being adjusted. This function is not possible to perform with the preceding Taiwan patent.

Other embodiments will be described hereinafter and it is noted that the following embodiments are capable of performing the same functions as the first embodiment except some of the following embodiments without providing the frequency modulation chamber 227.

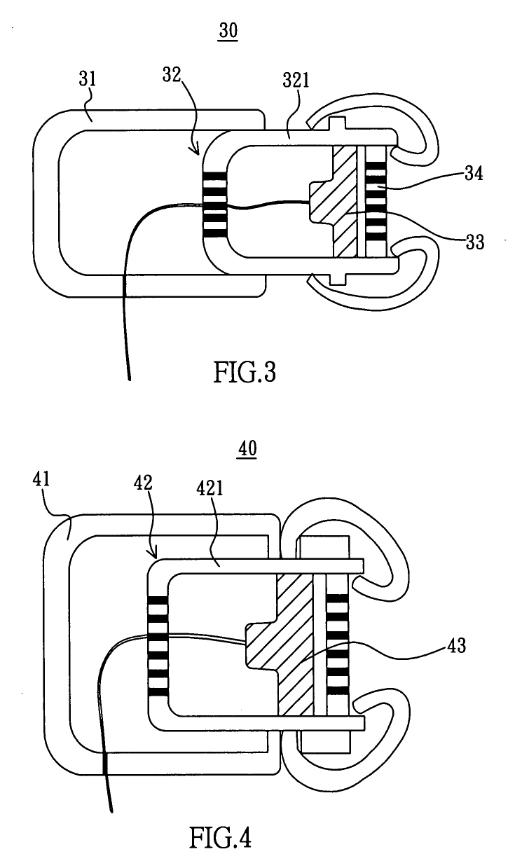

Referring to FIGS. 2 and 3, the second embodiment of the present invention is illustrated. The earphone 30 of the second embodiment includes an earphone casing 31, a speaker module 32 and a speaker unit 33. The earphone 30 is about the same as the earphone 20 except the differences of the earphone casing 31 providing piecing holes for the electrical cord without rear through holes, the front end of the earphone casing 31 being joined to the rear end of the speaker casing 321 instead of being joined to the cover 34 and no frequency modulation chamber being provided.

Referring to FIGS. 3 and 4, the third embodiment is illustrated. The earphone 40 of the third embodiment includes an earphone casing 41, a speaker module 42 and a speaker unit 43. The earphone 40 is about the same as the earphone 20 except the difference of the earphone casing 41 being joined to the front end of the speaker casing 421.

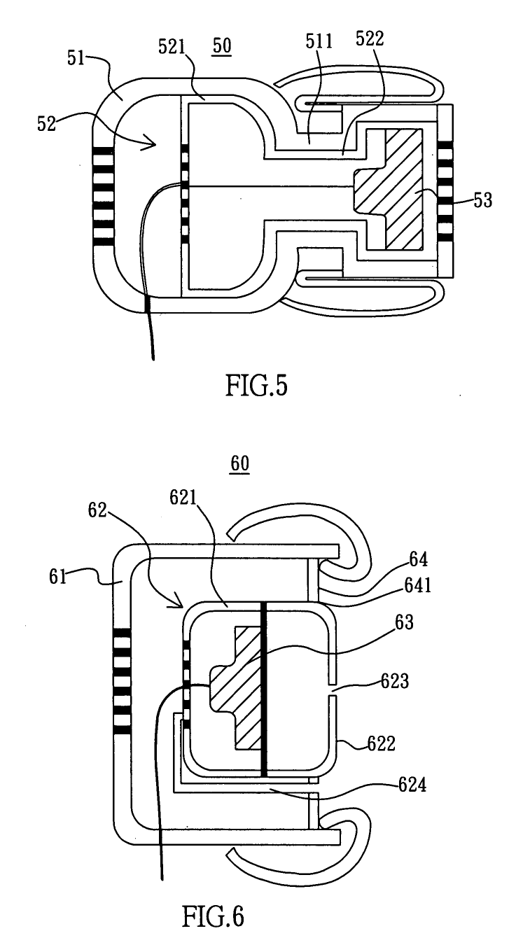

Referring to FIGS. 2 and 5, the fourth embodiment is illustrated. The earphone 50 of the fourth embodiment includes an earphone casing 51, a speaker module 52 and a speaker unit 53. The earphone 50 is about the same as the earphone 20 except the differences of the front section of the earphone casing 51 being joined to a lateral wall of the speaker casing 521 instead of a clearance between the front section of the earphone casing 21 and the lateral wall of the speaker casing 221 and the earphone casing 51 and the speaker casing 521 providing corresponding neck sections 511, 522 instead of no neck sections being provided to correspond to each other at the earphone casing 21 and speaker casing 221.

Referring to FIGS. 2 and 6, the fifth embodiment is illustrated. The earphone 60 of the fifth embodiment includes an earphone casing 61, a speaker module 62 and a speaker unit 63. The earphone 60 is about the same as the earphone 20 except the differences of the front end of the speaker casing 621 being joined to a front cover 622 with front through holes 623 and the cover 64 providing a through hole 641 for the front end of the front cover 622 extending outward.

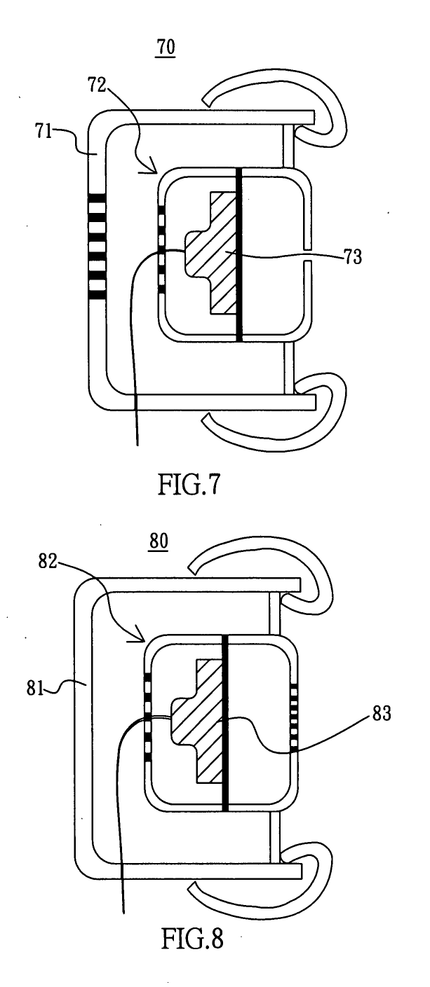

Referring to FIGS. 6 and 7, the sixth embodiment is illustrated. The earphone 70 of the sixth embodiment includes an earphone casing 71, a speaker module 72 and a speaker unit 73. The earphone 70 is about the same as the earphone 60 except the difference of no frequency modulation chamber 624 being provided.

Referring to FIGS. 7 and 8, the seventh embodiment is illustrated. The earphone 80 of the seventh embodiment includes an earphone casing 81, a speaker module 82 and a speaker unit 83. The earphone 80 is about the same as the earphone 70 except the difference of the earphone casing 81 only providing piercing holes for the electrical cord without rear through holes.

It is appreciated that an earphone and a tuning module of a speaker for the earphone according to the present invention is capable of allowing the same speaker unit to provide different sounds or different speaker units to provide better sounds by means of adjusting size position of the rear mouth of the speaker under a condition of being without changing configuration and size of the speaker casing.

While the invention has been described with referencing to preferred embodiments thereof, it is to be understood that modifications or variations may be easily made without departing from the spirit of this invention, which is defined by the appended claims.

What is claimed is:

1. A tuning module of a speaker for an earphone comprising:
a speaker casing providing a resonance chamber; and
a speaker unit being received in said resonance chamber;
wherein said speaker casing has a front mouth and a rear mouth; said rear mouth further comprises: a plurality of piercing holes such that characteristics of different sounds are capable of emitted by means of size and position of said rear mouth being adjustably reset under a condition of said chamber being not changed.

2. The tuning module of a speaker for an earphone as defined in claim 1 further comprises an electrical cord to electrically connect said speaker unit.

3. The tuning module of a speaker for an earphone as defined in claim 1, the front end of said speaker casing is joined to a cover and said cover at least has a first aperture being disposed in front of said speaker unit.

4. The tuning module of a speaker for an earphone as defined in claim 3, wherein the front end of said speaker casing is joined to a front cover and said front cover has a front through hole.

5. The tuning module of a speaker for an earphone as defined in claim 3, wherein said cover has a second aperture and a frequency modulation chamber is provided to communicate with said piercing hole and said second hole.

6. The tuning module of a speaker for an earphone as defined in claim 4, wherein said piercing hole communicates with a rear end of a frequency modulation chamber and the front end of said frequency modulation chamber extends to a lateral side of said front cover.

7. An earphone comprising:
an earphone casing providing a front opening; and
a tuning module for a speaker being disposed at an inner side of said front opening and further comprising:
a speaker casing providing a space; and
a speaker unit being received in said space;
wherein said speaker casing has a front mouth and a rear mouth and said rear mouth further provides a plurality of piercing holes such that characteristics of different sounds are capable of emitted by means of size and position of said rear mouth being adjustably reset under a condition of said chamber being not changed.

8. The earphone as defined in claim 7, wherein the front end of said earphone casing, the front end of said speaker casing and the front end of said speaker unit are joined to a cover respectively and said cover at least has a first aperture, which is disposed in front of said speaker unit.

9. The earphone as defined in claim 7, wherein the front end of said speaker casing is joined to a front cover and said front cover at least has a front though hole; the front end of said earphone is joined to a cover and said cover has a through hole for the front end of said front cover extending outward.

10. The earphone as defined in claim 7, wherein the front end of said speaker casing is joined to a cover and said cover at least has a first aperture being disposed in front of said speaker unit.

11. The earphone as defined in claim 8, wherein said cover has a second aperture and a frequency modulation chamber is provided to communicate with said piercing hole and said second aperture.

12. The earphone as defined in claim 9, wherein said cover has a second aperture and a frequency modulation chamber is provided to communicate with said piercing hole and said second aperture.

13. The earphone as defined in claim 10, wherein said earphone casing has a piercing hole for an electric cord extends outward and the front end of said earphone casing is joined to the rear end of said speaker casing.

14. The earphone as defined in claim 10, wherein said earphone casing has a piercing hole for an electric cord extends outward and the front end of said earphone casing is joined to the front end of said speaker casing.

15. The earphone as defined in claim 10, wherein a front section of said earphone casing is joined to a lateral wall of said speaker casing and said earphone casing and said speaker casing have a neck part respectively to correspond to each other.

16. The earphone as defined in claim 11, wherein said earphone casing at least has either a rear through hole or a piercing hole.

17. The earphone as defined in claim 12, wherein said earphone casing at least has either a rear through hole or a piercing hole.

18. The earphone as defined in claim 7 further comprises an electrical cord to electrically connect with said speaker unit; said earphone casing at least has either a rear through hole or a piercing hole; said electrical cord extends outward via said piercing hole of said speaker casing and said rear through hole or said piercing hole of said earphone casing.

19. The earphone as defined in claim 7, wherein the front end of said earphone casing is joined to an ear pad.

20. The earphone as defined in claim 7, wherein the front end of said speaker casing is joined to an ear pad.
